(19) United States
(12) Patent Application Publication
(10) Pub. No.: US 2016/0273506 A1
(43) Pub. Date: Sep. 22, 2016

(54) CONTROL DEVICE AND CONTROL METHOD FOR INTERNAL COMBUSTION ENGINE

(71) Applicant: TOYOTA JIDOSHA KABUSHIKI KAISHA, Toyota-shi, Aichi-ken (JP)

(72) Inventor: Junta MISAWA, Okazaki-shi (JP)

(73) Assignee: TOYOTA JIDOSHA KABUSHIKI KAISHA, Toyota-shi, Aichi-ken (JP)

(21) Appl. No.: 15/032,676

(22) PCT Filed: Nov. 6, 2014
(86) PCT No.: PCT/IB2014/002362

§ 371 Date: Apr. 28, 2016

(30) Foreign Application Priority Data
Nov. 12, 2013 (JP) 2013-234200

(51) Int. Cl. F02N 11/08; F02D 41/04; F02D 41/00

(52) U.S. Cl. CPC F02N 11/0829; F02D 41/0032; F02D 41/0045; F02D 41/042; F02N 2200/023; F02D 2200/021

(57) ABSTRACT

A control device for an internal combustion engine, the control device includes an electronic control unit configured to: (a) control execution of an automatic stop to stop an engine operation based on meeting of an automatic stop condition, (b) control execution of a purge cut to stop the release of the fuel vapor by the purge device, (c) estimate a concentration of the fuel vapor remaining in the intake passage in a state where the purge cut is executed as a purge gas concentration when engine temperature is higher than a reference temperature, and delay the execution of the automatic stop, even when the automatic stop condition is met, until the purge gas concentration decreases to be equal to or lower than a reference concentration, and (d) execute the automatic stop, without delaying the execution of the automatic stop, when the engine temperature is equal to or lower than the reference temperature.

### BACKGROUND OF THE INVENTION

1. Field of the Invention

The invention relates to a control device and a control method for an internal combustion engine.

2. Description of Related Art

In the related art, an internal combustion engine that performs automatic stop/start-up control to stop an engine operation when an automatic stop condition is met and resume the engine operation when an automatic start-up condition is met is known. Also, an internal combustion engine including a purge mechanism that releases fuel vapor, which is generated when a fuel in a fuel tank is evaporated, into intake air is known. Japanese Patent Application Publication No. 2008-045527 (JP 2008-045527 A) discloses an example of an internal combustion engine in which the automatic stop/start-up control and the purge mechanism are combined with each other. The internal combustion engine is configured to close a purge valve when the automatic stop condition is met, and execute automatic stop after scavenging the fuel vapor which is guided to an intake passage by the purge mechanism.

A control device that is disclosed in Japanese Patent Application Publication No. 2008-045527 (JP 2008-045527 A) allows the automatic stop to be executed after the fuel vapor guided to the intake passage by the purge mechanism is scavenged through scavenging processing. Accordingly, a state where a high-concentration air-fuel mixture that contains the fuel vapor remaining in the intake passage is present in a combustion chamber is suppressed when the engine operation is stopped by stopping fuel injection and ignition, and occurrence of auto-ignition is suppressed.

### SUMMARY OF THE INVENTION

In the control device that is disclosed in Japanese Patent Application Publication No. 2008-045527 (JP 2008-045527 A), termination of the scavenging processing is a condition for performing the automatic stop, and thus the scavenging processing has to be performed before the automatic stop is performed. In other words, the execution of the automatic stop is delayed while the scavenging processing is executed. As a result, a period when the engine operation continues is lengthened, and a fuel consumption suppression effect from the execution of the automatic stop may be impaired.

The invention provides a control device and a control method for an internal combustion engine that is capable of suppressing both auto-ignition by fuel vapor remaining in an intake passage and fuel consumption.

According to a first aspect of the invention, there is provided a control device for an internal combustion engine, the internal combustion engine including a purge device configured to release fuel vapor in a fuel tank to an intake passage. The control device includes an electronic control unit configured to: (a) control execution of an automatic stop to stop an engine operation based on meeting of an automatic stop condition, (b) control execution of a purge cut to stop the release of the fuel vapor by the purge device, (c) estimate a concentration of the fuel vapor remaining in the intake passage in a state where the purge cut is executed as a purge gas concentration when engine temperature is higher than a reference temperature, and delay the execution of the automatic stop, even when the automatic stop condition is met, until the purge gas concentration decreases to be equal to or lower than a reference concentration, and (d) execute the automatic stop, without delaying the execution of the automatic stop, when the engine temperature is equal to or lower than the reference temperature.

According to this aspect, the automatic stop is delayed, until the purge gas concentration decreases to be equal to or lower than the reference concentration, when the engine temperature is higher than the reference temperature. While the automatic stop is delayed in a state where the purge cut is executed, the fuel vapor that is already released to the intake passage is combusted through the engine operation, and thus the purge gas concentration gradually decreases. When the purge gas concentration decreases, auto-ignition is unlikely to occur.

According to this aspect, the automatic stop is executed after the purge gas concentration decreases through the delay of the automatic stop when the purge gas concentration is high and the auto-ignition is likely to occur. Accordingly, the occurrence of the auto-ignition can be suppressed. When the purge gas concentration is equal to or lower than the reference concentration in the first place, the automatic stop is not delayed and thus the automatic stop is promptly executed.

The auto-ignition is unlikely to occur, even if the purge gas concentration is high, when the engine temperature is low. In contrast, the automatic stop is executed, without being delayed, when the engine temperature is equal to or lower than the reference temperature in this configuration.

According to this aspect, the automatic stop is delayed, until the purge gas concentration becomes low, in a situation in which the engine temperature is high, the purge gas concentration is high, and the auto-ignition is likely to occur. When the engine temperature is low and the auto-ignition is unlikely to occur despite the high purge gas concentration, the automatic stop is promptly executed regardless of whether or not the purge gas concentration is high.

According to this aspect, it is determined whether or not the situation is prone to the occurrence of the auto-ignition based on the engine temperature and the purge gas concentration. When the situation is prone to the occurrence of the auto-ignition, the occurrence of the auto-ignition is suppressed through the delay of the automatic stop. When the situation is not prone to the occurrence of the auto-ignition in the first place, the automatic stop can be promptly executed without delaying the automatic stop.

Therefore, according to this aspect, both the auto-ignition by the fuel vapor remaining in the intake passage and fuel consumption can be suppressed without blindly delaying the automatic stop.

In the control device according to this aspect, the electronic control unit may be configured to perform automatic stop execution availability pre-determination to determine whether or not the automatic stop is in an executable state. The electronic control unit may be configured to execute the purge cut, before the automatic stop condition is met, based on a result of the automatic stop execution availability pre-determination.

It is effective to delay the automatic stop until the purge gas concentration decreases in order to suppress the occurrence of the auto-ignition. However, the delay of the automatic stop also causes fuel consumption to continue.

According to this aspect, the purge cut is executed based on a result of automatic stop execution request pre-determination that is performed before the automatic stop condition is met, and thus the purge gas concentration can be decreased even before the automatic stop is delayed. Accordingly, a period that is required from the beginning of the delay of the automatic stop after the automatic stop condition is met to the decrease in the purge gas concentration to or below the reference concentration can be shortened, and a period when the automatic stop is delayed can be shortened. In other words, according to this configuration, purge cut execution timing can be put forward and a situation in which the auto-ignition is unlikely to occur despite the execution of the automatic stop can be promptly produced. Eventually, the period when the automatic stop is delayed can be shortened, and fuel consumption can be suppressed.

In the control device according to this aspect, the electronic control unit may be configured to set the reference concentration to be higher when the engine temperature is low than when the engine temperature is high. A lower limit value of the purge gas concentration at which the auto-ignition may occur has a correlation with the engine temperature. In other words, as the engine temperature decreases, the lower limit value of the purge gas concentration at which the auto-ignition may occur increases and the auto-ignition is unlikely to occur even when the purge gas concentration is high. Accordingly, the control device may be configured to set the reference concentration to be higher when the engine temperature is low than when the engine temperature is high as in the configuration described above.

According to this aspect, the reference concentration can be variably set based on the engine temperature in accordance with the tendency in which the lower limit value of the purge gas concentration at which the auto-ignition may occur changes according to the engine temperature. Accordingly, resolution of a situation in which the auto-ignition is likely to occur through the delay of the automatic stop can be further accurately determined based on the purge gas concentration.

In the control device according to this aspect, the electronic control unit may be configured to determine whether or not the engine temperature is higher than the reference temperature based on a temperature of hydraulic oil of the internal combustion engine. The temperature of the hydraulic oil that circulates inside the internal combustion engine increases as the engine temperature increases. In other words, the temperature of the hydraulic oil has a correlation with the engine temperature. Accordingly, it can be determined whether or not the engine temperature is higher than the reference temperature based on the temperature of the hydraulic oil after the temperature of the hydraulic oil is checked as in the aspect described above.

In the control device according to this aspect, the electronic control unit may be configured to determine whether or not the engine temperature is higher than the reference temperature based on intake temperature. The intake temperature changes according to the environmental temperature at which the internal combustion engine is arranged. For example, the intake temperature is high when the internal combustion engine is operated in a high-temperature environment. The engine temperature is unlikely to increase when the environmental temperature is low. In other words, the environmental temperature is a parameter affecting engine temperature change. Accordingly, it is preferable to refer to the intake temperature, which has a correlation with the environmental temperature, as in the configuration described above, when it is determined whether or not the engine temperature is higher than the reference temperature.

According to a second aspect of the invention, there is provided a control method for an internal combustion engine, the internal combustion engine including a purge device configured to release fuel vapor in a fuel tank to an intake passage, and an electronic control unit. The control method includes controlling, by the electronic control unit, execution of an automatic stop to stop an engine operation based on meeting of an automatic stop condition, controlling, by the electronic control unit, execution of a purge cut to stop the release of the fuel vapor by the purge device, estimating, by the electronic control unit, a concentration of the fuel vapor remaining in the intake passage in a state where the purge cut is executed as a purge gas concentration when engine temperature is higher than a reference temperature and delaying, by the electronic control unit, the execution of the automatic stop, even if the automatic stop condition is met until the purge gas concentration decreases to be equal to or lower than a reference concentration, and executing, by the electronic control unit, the automatic stop, without delaying the execution of the automatic stop when the engine temperature is equal to or lower than the reference temperature.

According to this aspect, it is determined whether or not the situation is prone to the occurrence of the auto-ignition based on the engine temperature and the purge gas concentration. When the situation is prone to the occurrence of the auto-ignition, the occurrence of the auto-ignition is suppressed through the delay of the automatic stop. When the situation is not prone to the occurrence of the auto-ignition in the first place, the automatic stop can be promptly executed without delaying the automatic stop.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram illustrating relationship between an electronic control unit that is an embodiment of a control device for an internal combustion engine and the internal combustion engine that is a control object of the electronic control unit;

FIG. 2 is a flowchart illustrating a procedure of a series of processing relating to delay control that is executed by the electronic control unit;

FIG. 3 is a timing chart illustrating a relationship between vehicle speed, purge gas concentration change, change timing of various types of flags, and automatic stop execution timing at a time when the delay control is executed; and

FIG. 4 is a map illustrating an area where automatic stop is delayed through delay control and an area where the delay control is not executed at all on a coordinate plane where purge gas concentration and engine temperature are variables.

### DETAILED DESCRIPTION OF EMBODIMENTS

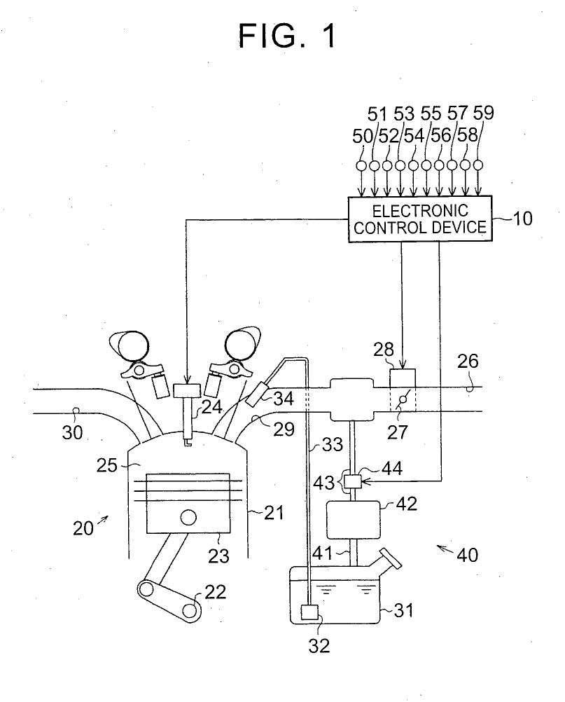

Hereinafter, an embodiment, in which a control device for an internal combustion engine is materialized as an electronic control unit 10 that controls an internal combustion engine 20 mounted on a vehicle, will be described with reference to FIGS. 1 to 4. As illustrated in FIG. 1, a throttle valve 27 is provided in an intake passage 26 of the internal combustion engine 20. The degree of opening of the throttle valve 27 is adjusted by driving control of a throttle motor 28, and an intake amount is adjusted by the adjustment of the degree of opening. The intake passage 26 is connected to a combustion chamber 25 of a cylinder 21 via an intake port 29. A fuel injection valve 34, which injects a fuel that is stored in a fuel tank 31 to the intake port 29, is provided in the intake passage 26. A feed pump 32, which pumps the fuel to the fuel injection valve 34 through a fuel passage 33, is provided in the fuel tank 31.

In the combustion chamber 25, an air-fuel mixture of intake air that is taken in from the intake passage 26 and the fuel that is injected from the fuel injection valve 34 is ignited by an ignition plug 24 and is combusted. The combustion allows a piston 23 to reciprocate in the cylinder 21 and a crankshaft 22 to rotate. Exhaust after the combustion is sent out to an exhaust passage 30 that is connected to the combustion chamber 25.

A vapor passage 41, which allows fuel vapor that is generated in the fuel tank 31 to flow, is connected to an upper portion of the fuel tank 31. The vapor passage 41 is connected to a canister 42 in which an adsorbent that adsorbs the fuel vapor is included. The canister 42 is connected, via a purge passage 43, to a site of the intake passage 26 on a downstream side from the throttle valve 27. A purge control valve 44, which adjusts a communication state of the purge passage 43, is provided in the purge passage 43. The vapor passage 41, the canister 42, the purge passage 43, and the purge control valve 44 constitute a purge device 40 that processes the fuel vapor generated in the fuel tank 31 by releasing (purging) the fuel vapor to the intake passage 26.

In the purge device 40, the fuel vapor that is generated in the fuel tank 31 is sent to the canister 42 through the vapor passage 41. Fuel components of the fuel vapor that is sent to the canister 42 are adsorbed by the adsorbent in the canister 42. In a case where the purge control valve 44 is open during an engine operation, air is suctioned through the purge passage 43 from the canister 42 due to intake negative pressure that is generated on a downstream side of the throttle valve 27. The fuel components that are adsorbed by the adsorbent in the canister 42 are desorbed from the adsorbent due to the air suctioning, and are purged to the intake passage 26 with the suctioned air. The fuel components that are purged to the intake passage 26 are combusted in the combustion chamber 25 with the fuel injected from the fuel injection valve 34.

Various types of sensors and switches described below are electrically connected to the electronic control unit 10 that controls the internal combustion engine 20. A crank position sensor 50 is a sensor that outputs a signal in response to a change in a crank angle that is a rotation angle of the crankshaft 22. A throttle position sensor 51 is a sensor that detects the degree of opening of the throttle valve 27. An air flow meter 52 is a sensor that detects intake temperature which is the temperature of the air flowing in the intake passage 26 and the intake amount which is a flow rate of the air flowing in the intake passage 26. A negative pressure sensor 53 is a sensor that detects the pressure of the intake passage 26 on a downstream side from the throttle valve 27. An air-fuel ratio sensor 54 is a sensor that outputs a signal which is proportional to the concentration of oxygen contained in the exhaust. A water temperature sensor 55 is a sensor that detects coolant temperature which is the temperature of a coolant circulating in the internal combustion engine 20. An oil temperature sensor 56 is a sensor that detects the temperature of hydraulic oil which is supplied to portions of the internal combustion engine 20. A vehicle speed sensor 57 is a sensor that detects vehicle speed which is the speed of the vehicle on which the internal combustion engine 20 is mounted. An accelerator position sensor 58 is a sensor that detects an accelerator operation amount. A brake switch 59 is a switch that detects a brake being in operation.

The electronic control unit 10 executes various types of arithmetic processing based on the signals which are input from the sensors and switches described above, and controls the portions of the internal combustion engine 20 including the purge device 40. For example, the electronic control unit 10 calculates engine rotational speed, which is the rotational speed of the crankshaft 22, based on the signal that is output by the crank position sensor 50. The electronic control unit 10 drives the throttle motor 28, the ignition plug 24, the fuel injection valve 34, and the like based on the accelerator operation amount, the engine rotational speed, the vehicle speed, and the like so that the internal combustion engine 20 generates required torque. The electronic control unit 10 catches deviation of the air-fuel ratio of the air-fuel mixture based on the signal that is output from the air-fuel ratio sensor 54, and executes air-fuel ratio feedback control by finely adjusting a fuel injection amount with respect to the intake amount so that the air-fuel ratio is adjusted to an appropriate value. The electronic control unit 10 adjusts the fuel injection amount and ignition timing according to the coolant temperature, and promotes warm-up of the internal combustion engine 20.

The electronic control unit 10 executes automatic stop/start-up control by stopping the engine operation when an automatic stop condition is met and resuming the engine operation when an automatic start-up condition is met. Examples of the automatic stop condition that can be set include a condition that all of the three conditions of (A) the vehicle speed being “zero”, (B) the accelerator operation amount being “zero”, and (C) the brake being in operation are met. Examples of the automatic start-up condition that can be set include a condition that at least one of (A) to (C) described above are not met to cause the automatic stop condition not to be met.

The electronic control unit 10 controls the purge control valve 44 and processes the fuel vapor generated in the fuel tank 31 by purging the fuel vapor to the intake passage 26. For example, the electronic control unit 10 opens the purge control valve 44 during the engine operation to connect, the intake passage 26 to the canister 42 via the purge passage 43. As a result, the fuel components that are adsorbed by the canister 42 as described above are purged to the intake passage 26 with the air and are combusted in the combustion chamber 25.

In a case where the fuel vapor continues to flow into the intake passage 26 or a large quantity of the fuel vapor remains in the intake passage 26 during the automatic stop of the engine operation after the automatic stop condition is met, a large quantity of the fuel remains in the combustion chamber 25. Accordingly, the fuel may be prone to auto-ignition as the pressure of the combustion chamber 25 increases as a result of rise of the piston 23.

In order to suppress the occurrence of the auto-ignition by the fuel vapor that is released to the intake passage 26 through the purge device 40, the electronic control unit 10 executes delay control by delaying the automatic stop while executing purge cut by closing the purge control valve 44 and stopping the release of the fuel vapor.

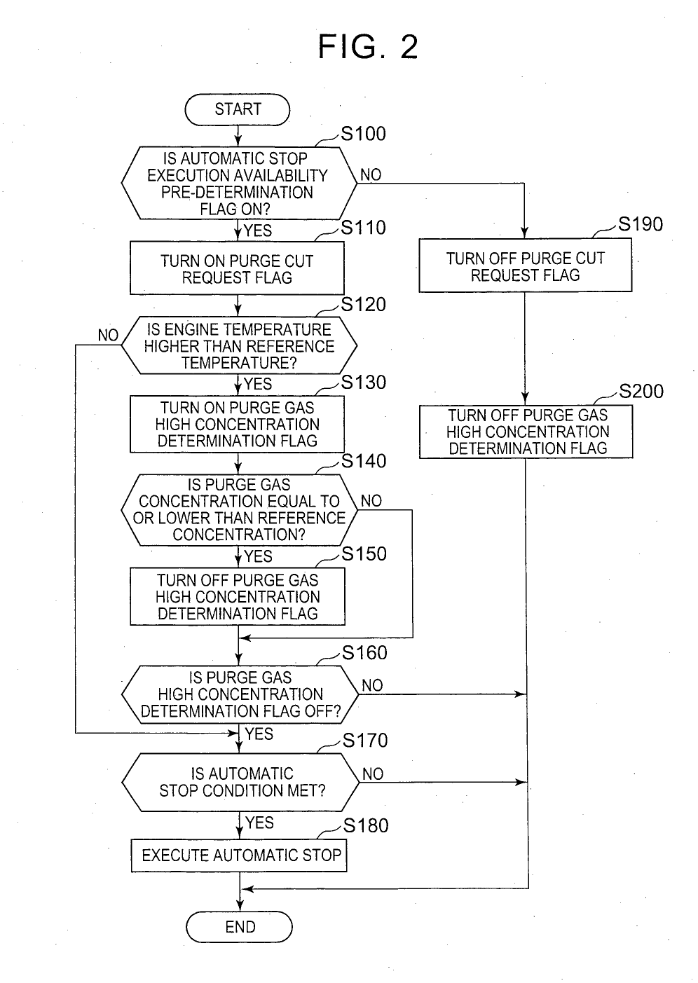

Next, a procedure of a series of processing relating to the delay control will be described with reference to FIG. 2. A series of the processing is executed repeatedly at a predetermined control cycle during the engine operation by the electronic control unit 10. After a series of the processing is initiated, it is determined first whether or not an automatic stop execution availability pre-determination flag is ON in Step S100. The automatic stop execution availability pre-determination flag is a flag that is turned ON or OFF based on a determination result of automatic stop execution availability pre-determination. The automatic stop execution availability pre-determination is determination, prior to the meeting of the automatic stop condition, on whether or not the automatic stop is in an executable state. In the automatic stop execution availability pre-determination, it is determined that the automatic stop is in an executable state when, for example, the vehicle speed is equal to or lower than a predetermined value exceeding “zero” and the brake, a transmission, and a battery are normal. The automatic stop execution availability pre-determination flag is turned ON when the automatic stop is determined to be in an executable state. When the automatic stop is determined not to be in an executable state through the automatic stop execution availability pre-determination, the automatic stop execution availability pre-determination flag is turned OFF.

After the automatic stop execution availability pre-determination flag is determined to be ON in Step S100 (S100: YES), the processing proceeds to Step S110.

A purge cut request flag is ON in Step S110. In the subsequently performed processing in Step S120, it is determined whether or not engine temperature is higher than a reference temperature. Herein, the reference temperature is set to a value that is equal to a lower limit value of the engine temperature at which the auto-ignition occurs. Then, the engine temperature is estimated based on the temperature of the hydraulic oil detected by the oil temperature sensor 56, and it is determined whether or not the estimated engine temperature is higher than the reference temperature. During the estimation of the engine temperature, the intake temperature that has a high correlation with environmental temperature affecting engine temperature change, that is, the temperature of air in an engine compartment where the internal combustion engine 20 is arranged, may also be referred to.

After the engine temperature is determined to be higher than the reference temperature in Step S120 (S120: YES), processing in Step S130 is performed. In Step S130, a purge gas high concentration determination flag is ON. In the processing in Step S140 that follows Step S130, it is determined whether or not purge gas concentration, which is the concentration of the fuel vapor remaining in the intake passage 26, is equal to or lower than a reference concentration. Herein, the reference concentration is set to a value that is equal to a lower limit value of the purge gas concentration at which the auto-ignition occurs.

The purge gas concentration is estimated by using a model with which a purge gas flow rate is estimated. In this model, the pressure that is detected by the negative pressure sensor 53 and the degree of throttle opening that is detected by the throttle position sensor 51 are input as variables. In this model, it is estimated that the negative pressure acting on the purge passage 43 increases and the purge gas flow rate increases as the pressure detected by the negative pressure sensor 53 decreases and the degree of throttle opening decreases. The purge gas concentration at a time when the purge control valve 44 is open is estimated based on the purge gas flow rate that is estimated in this manner and oxygen concentration that is detected by the air-fuel ratio sensor 54. The purge gas concentration decreases while the purge control valve 44 is closed because no new fuel vapor is released to the intake passage 26. While the purge control valve 44 is closed, the decreasing purge gas concentration can be estimated based on, for example, the intake amount that is detected by the air flow meter 52 and the oxygen concentration that is detected by the air-fuel ratio sensor 54.

After it is determined that the purge gas concentration is equal to or lower than the reference concentration in Step S140 (S140: YES), the processing in Step S150 is executed. In Step S150, the purge gas high concentration determination flag that is turned ON in Step S130 is turned OFF. When the purge gas high concentration determination flag is turned OFF in Step S150, the processing proceeds to Step S160. When the purge gas concentration is higher than the reference concentration, a negative determination is made in Step S140 (S140: NO), the processing in Step S150 is skipped, and the processing in Step S160 is performed with the purge gas high concentration determination flag remaining in an ON state.

In Step S160, it is determined whether or not the purge gas high concentration determination flag is OFF. After the purge gas high concentration determination flag is determined to be OFF in Step S160 (S160: YES), the processing proceeds to Step S170. In Step S170, it is determined whether or not the automatic stop condition is met. Herein, all of the three conditions of (A) the vehicle speed being “zero”, (B) the accelerator operation amount being “zero”, and (C) the brake being in operation being met is set as the automatic stop condition as described above. In other words, in Step S170, it is determined that the automatic stop condition is met when all of the three conditions of (A) to (C) are met.

After the automatic stop condition is determined to be met in Step S 170 (Step S170: YES), the processing in Step S180 is performed and the automatic stop is executed. When the automatic stop is executed through Step S180, this routine is temporarily terminated.

When it is determined that the automatic stop condition is not met in Step S170 (Step S170: NO), the processing in Step S180 is skipped and this routine is temporarily terminated without the execution of the automatic stop.

When it is determined that the purge gas high concentration determination flag is ON in Step S160 (S160: NO), the processing in Step S170 and Step S180 is skipped and a series of the processing is temporarily terminated. In this case, the processing (Step S170 and Step S180) for executing the automatic stop according to whether or not the automatic stop condition is met is not executed, and thus the automatic stop is not executed even if the automatic stop condition is met.

When it is determined that the engine temperature is equal to or lower than the reference temperature in the processing in Step S120 (S120: NO), the processing in Steps S130 to S160 is skipped and the processing proceeds to Step S170. In this case, the processing (Step S140) for determining whether or not the purge gas concentration is equal to or lower than the reference concentration and the processing (Step S160) for determining whether or not the purge gas high concentration determination flag is OFF are not performed and it is determined whether or not the automatic stop condition is met regardless of the purge gas concentration.

After it is determined that an automatic stop execution request pre-determination flag is OFF in Step S100 (Step S100: NO), the processing proceeds to Step S190.

Then, the purge cut request flag is turned OFF in Step S190 and the purge gas high concentration determination flag is turned OFF in the subsequently executed processing in Step S200 before a series of the processing is temporarily terminated. In this case, determination on whether or not the automatic stop condition is met is not made and the automatic stop is not executed.

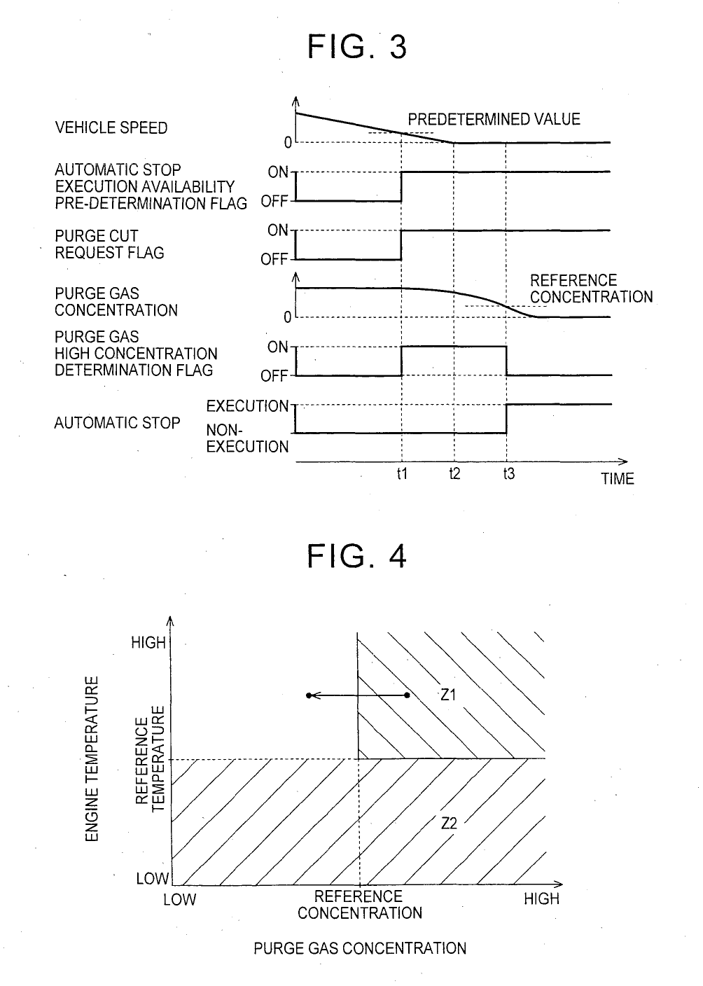

Next, an effect that is generated by the execution of a series of the processing described above will be described with reference to FIG. 3. FIG. 3 illustrates a state where the brake is in operation, the vehicle is decelerated and stopped, and the automatic stop is executed in a state where the engine temperature is higher than the reference temperature. An accelerator is not in operation in this case.

As illustrated in the vehicle speed timing chart in FIG. 3, the vehicle speed is higher than a predetermined value until timing t1. Accordingly, the automatic stop execution request pre-determination flag is OFF (Step S100: NO) as illustrated in the automatic stop execution availability pre-determination flag timing chart, and both of the purge cut request flag and the purge gas high concentration determination flag are OFF (Step S190 and Step S200) as illustrated in the purge cut request flag and purge gas high concentration determination flag timing charts. In this case, the purge cut is not executed, and the purge gas concentration is higher than the reference concentration as illustrated in the purge gas concentration timing chart.

When the vehicle is decelerated as illustrated in the vehicle speed timing chart and the vehicle speed is equal to or lower than a predetermined value at timing t1, the automatic stop execution request pre-determination flag is turned ON (Step S100: YES) as illustrated in the automatic stop execution availability pre-determination flag timing chart and the purge cut request flag is turned ON (Step S110) as illustrated in the purge cut request flag timing chart. When the purge cut request flag is turned ON in this manner, the electronic control unit 10 closes the purge control valve 44 and executes the purge cut.

In this case, the engine temperature is higher than the reference temperature (Step S120: YES), and the purge gas high concentration determination flag is turned ON (Step S130) as illustrated in the purge gas high concentration determination flag timing chart. If the purge gas concentration is equal to or lower than the reference concentration herein (Step S140: YES), the purge gas high concentration determination flag is immediately turned OFF (Step S150). However, in this case, the purge gas concentration is higher than the reference concentration (Step S140: NO) as illustrated in the purge gas concentration timing chart, and thus the purge gas high concentration determination flag remains ON as illustrated in the purge gas high concentration determination flag timing chart.

The automatic stop condition is met when the vehicle is further decelerated, the vehicle is stopped at timing t2, and the vehicle speed becomes “zero” as illustrated in the vehicle speed timing chart. However, in this case, the purge gas concentration is higher than the reference concentration (Step S140: NO) as illustrated in the purge gas concentration timing chart and the purge gas high concentration determination flag is ON (Step S160: NO) as illustrated in the purge gas high concentration determination flag timing chart. Accordingly, as described above, the processing (Step S170 and Step S180) for executing the automatic stop according to whether or not the automatic stop condition is met is not executed herein, and the automatic stop is not executed.

When the purge cut continues to decrease the purge gas concentration and the purge gas concentration becomes equal to or lower than the reference concentration at timing t3 (Step S140: YES) as illustrated in the purge gas concentration timing chart, the purge gas high concentration determination flag is turned OFF (Step S150) as illustrated in the purge gas high concentration determination flag timing chart. As a result, the processing (Step S170 and Step S180) for executing the automatic stop according to whether or not the automatic stop condition is met is executed. In this case, the vehicle speed is “zero” as illustrated in the vehicle speed timing chart and the automatic stop condition is met (Step S170: YES), and thus the automatic stop is executed (Step S180).

In other words, the execution of a series of the processing described with reference to FIG. 2 results in the non-execution of the automatic stop until the purge gas concentration becomes equal to or lower than the reference concentration through the processing in Steps S130 to S160 in a case where the engine temperature is higher than the reference temperature (Step S120: YES). As a result, the automatic stop is not executed and is delayed until the purge gas concentration decreases to be equal to or lower than the reference concentration at timing t3 even if the automatic stop condition is met at timing t2.

In a case where the engine temperature is equal to or lower than the reference temperature (Step S120: NO), the processing in Steps S130 to S160, that is, the delay control, in a series of the processing described with reference to FIG. 2 is not executed. As a result, the automatic stop is executed regardless of the purge gas concentration when the automatic stop condition is met. Accordingly, in this case, the automatic stop is not delayed even if the purge gas concentration is higher than the reference concentration, and the automatic stop is promptly executed.

As described above, the execution of a series of the processing described with reference to FIG. 2 results in the non-execution of the automatic stop, even if the automatic stop condition is met, in an area Z1 where the engine temperature is higher than the reference temperature and the purge gas concentration is higher than the reference concentration as illustrated in FIG. 4. The automatic stop is delayed until the purge gas concentration decreases to be equal to or lower than the reference concentration as illustrated by the arrow in FIG. 4. When the purge gas concentration decreases to be equal to or lower than the reference concentration, the automatic stop is executed.

In an area Z2, where the engine temperature is equal to or lower than the reference temperature, the delay control (Steps S130 to S160) is not executed regardless of whether or not the purge gas concentration is higher than the reference concentration, and the automatic stop is executed when the automatic stop condition is met.

According to the embodiment described above, the following effects can be achieved.

(1) It is determined whether or not a situation is prone to the occurrence of the auto-ignition based on the engine temperature and the purge gas concentration so that the occurrence of the auto-ignition can be suppressed through the delay of the automatic stop when the situation is prone to the occurrence of the auto-ignition and the automatic stop can be promptly executed, without performing the delay of the automatic stop, when the situation is not prone to the occurrence of the auto-ignition in the first place. Accordingly, both the auto-ignition by the fuel vapor remaining in the intake passage 26 and fuel consumption can be suppressed without blindly delaying the automatic stop.

(2) The purge cut is executed based on the result of the automatic stop execution availability pre-determination, which is performed before the automatic stop condition is met, and thus the purge gas concentration can be decreased prior to the execution of the automatic stop. Accordingly, a period that is required from the beginning of the delay of the automatic stop after the automatic stop condition is met to the decrease in the purge gas concentration to or below the reference concentration can be shortened, and a period when the automatic stop is delayed can be shortened. In other words, purge cut execution timing can be put forward and a situation in which the auto-ignition is unlikely to occur despite the execution of the automatic stop can be promptly produced. Eventually, the period when the automatic stop is delayed can be shortened, and fuel consumption can be suppressed.

(3) In the internal combustion engine 20, the temperature of the hydraulic oil that circulates inside the internal combustion engine 20 increases as the engine temperature increases. In other words, the temperature of the hydraulic oil has a correlation with the engine temperature. The intake temperature changes according to the environmental temperature at which the internal combustion engine 20 is arranged. For example, the intake temperature is high when the internal combustion engine 20 is operated in a high-temperature environment. The engine temperature is unlikely to increase when the environmental temperature is low. In other words, the environmental temperature is a parameter affecting engine temperature change. Accordingly, it can be determined whether or not the engine temperature is higher than the reference temperature by referring to the temperature of the hydraulic oil and the intake temperature that can be detected by using the oil temperature sensor 56 which is provided so as to detect the temperature of the hydraulic oil and the air flow meter 52 which detects the intake temperature so as to detect an intake air amount. In other words, it can be determined whether or not the engine temperature is higher than the reference temperature without any sensor directly detecting the engine temperature having to be additionally provided.

The above-described embodiment can also be realized in appropriately modified forms as follows.

In the example above, it is determined whether or not the engine temperature is higher than the reference temperature by referring to the temperature of the hydraulic oil and the intake temperature. However, a method for estimating the engine temperature can be appropriately modified. For example, the coolant temperature has a correlation with the engine temperature as is the case with the temperature of the hydraulic oil. Accordingly, a configuration in which the coolant temperature is referred to instead of the temperature of the hydraulic oil can also be adopted. In addition, the engine temperature may be estimated by referring to a combination of a plurality of parameters having a correlation with the engine temperature, such as the oil temperature of the hydraulic oil, the coolant temperature, and the intake temperature, if this allows the engine temperature to be estimated. Also, the engine temperature may be estimated by referring to each one of the parameters. It may also be determined whether or not the engine temperature is higher than the reference temperature by providing a sensor that directly detects the engine temperature.

In the example of the above-described embodiment, the reference temperature is set to a value that is equal to the lower limit value of the temperature at which the auto-ignition occurs. However, the reference temperature is not limited to the value equal to the lower limit value. The following effects can be achieved when the reference temperature is a value that is different from the lower limit value. For example, the occurrence of the auto-ignition can be further reliably suppressed when the reference temperature is set to a value that is equal to or lower than the lower limit value. However, in this case, the frequency with which the delay control is executed increases, and thus the execution of the automatic stop is likely to be delayed and a fuel consumption suppression effect decreases. When the reference temperature is set to a value that is higher than the lower limit value, the frequency with which the delay control is executed decreases as the reference temperature increases, and the fuel consumption suppression effect is improved. However, in this case, an auto-ignition suppression effect decreases.

In the example of the above-described embodiment, the reference concentration is set to a value that is equal to the lower limit value of the concentration at which the auto-ignition occurs. However, the reference concentration is not limited to the value that is equal to the lower limit value. The following effects can be achieved when the reference concentration is a value that is different from the lower limit value. For example, the occurrence of the auto-ignition can be further reliably suppressed when the reference concentration is set to a value that is equal to or lower than the lower limit value. However, in this case, the period when the automatic stop is delayed is lengthened, and the fuel consumption suppression effect decreases. When the reference concentration is set to a value that is higher than the lower limit value, the period when the automatic stop is delayed is shortened as the reference concentration increases, and the fuel consumption suppression effect is improved. However, in this case, the auto-ignition suppression effect decreases.

In the example of the above-described embodiment, the reference concentration is a fixed value. However, the reference concentration can also be a variable value. The lower limit value of the purge gas concentration at which the auto-ignition may occur has a correlation with the engine temperature. In other words, as the engine temperature decreases, the lower limit value of the purge gas concentration at which the auto-ignition may occur increases and the auto-ignition is unlikely to occur even if the purge gas concentration is high. Accordingly, the modified embodiment can be configured to set reference concentration to be higher when the engine temperature is low than when the engine temperature is high. Specifically, a configuration in which the reference concentration increases as the engine temperature decreases and a configuration in which reference concentrations are respectively set with respect to a plurality of temperature ranges and a higher reference concentration is selected for a lower temperature range can be adopted.

When this configuration is adopted, the reference concentration can be variably set based on the engine temperature in accordance with the tendency in which the lower limit value of the purge gas concentration at which the auto-ignition may occur changes according to the engine temperature. Accordingly, resolution of a situation in which the auto-ignition is likely to occur through the delay control can be further accurately determined based on the purge gas concentration.

The example of the above-described embodiment uses a model for estimating the purge gas flow rate so as to estimate the purge gas concentration. However, the purge gas concentration can also be estimated by using any other method that allows the purge gas concentration to be estimated.

The purge cut may not be executed by control by the purge control valve 44. In an alternative configuration, the purge cut is executed with an air release valve that opens the purge passage 43 to the atmosphere provided in the purge passage 43 and the air release valve opened so that the intake negative pressure does not act on the canister 42.

In the above-described embodiment, the port injection internal combustion engine 20 that injects the fuel to the intake port 29 is suggested as an example of the internal combustion engine which is a control object of the electronic control unit 10. However, the control object of the electronic control unit 10 can also be a cylinder injection internal combustion engine that injects a fuel directly into the combustion chamber 25. Also, the control object can be an internal combustion engine adopting both of port injection and cylinder injection.

1.-10. (canceled)

11. A control device for an internal combustion engine, the internal combustion engine including a purge device configured to release fuel vapor in a fuel tank to an intake passage, the control device comprising:
an electronic control unit configured to:
perform automatic stop execution availability pre-determination to determine whether or not an automatic stop is in an executable state;
control execution of the automatic stop to stop an engine operation based on meeting of an automatic stop condition;
control execution of an purge cut to stop the release of the fuel vapor by the purge device;
execute the purge cut, before the automatic stop condition is met, based on a result of the automatic stop execution availability pre-determination;
estimate a concentration of the fuel vapor remaining in the intake passage in a state where the purge cut is executed as a purge gas concentration when engine temperature is higher than reference temperature, and delay the execution of the automatic stop, even when the automatic stop condition is met, until the purge gas concentration decreases to be equal to or lower than reference concentration; and
execute the automatic stop, without delaying the execution of the automatic stop, when the engine temperature is equal to or lower than the reference temperature, wherein the electronic control unit is configured to set the reference concentration to be higher when the engine temperature is low than when the engine temperature is high.

12. The control device according to claim 11,
wherein the electronic control unit is configured to determine whether or not the engine temperature is higher than the reference temperature based on a temperature of hydraulic oil of the internal combustion engine.

13. The control device according to claim 11,
wherein the electronic control unit is configured to determine whether or not the engine temperature is higher than the reference temperature based on intake temperature.

14. A control method for an internal combustion engine, the internal combustion engine including a purge device configured to release fuel vapor in a fuel tank to an intake passage, and an electronic control unit, the control method comprising:
performing by the electronic control unit, automatic stop execution availability pre-determination to determine whether or not an automatic stop is in an executable state;
controlling, by the electronic control unit, execution of the automatic stop to stop an engine operation based on meeting of an automatic stop condition;
controlling, by the electronic control unit, execution of a purge cut to stop the release of the fuel vapor by the purge device, wherein the purge cut is executed before the automatic stop condition is met based on a result of the automatic stop execution availability pre-determination;
estimating, by the electronic control unit, a concentration of the fuel vapor remaining in the intake passage in a state where the purge cut is executed as purge gas concentration when engine temperature is higher than reference temperature, and delaying, by the electronic control unit, the execution of the automatic stop, even when the automatic stop condition is met until the purge gas concentration decreases to be equal to or lower than reference concentration; and
executing, by the electronic control unit, the automatic stop, without delaying the execution of the automatic stop when the engine temperature is equal to or lower than the reference temperature,
wherein the reference concentration is set to be higher when the engine temperature is low than when the engine temperature is high.

15. The control method according to claim 14,
wherein it is determined whether the engine temperature is higher than the reference temperature based on a temperature of hydraulic oil of the internal combustion engine.

16. The control method according to claim 14,
wherein it is determined whether or not the engine temperature is higher than the reference temperature based on intake temperature.
